(19) United States
(12) Patent Application Publication
(10) Pub. No.: US 2026/0327154 A1
(43) Pub. Date: Oct. 22, 2026

(54) PVD COATED CERAMIC SUBSTRATES

(71) Applicant: Kennametal Inc., Latrobe, PA (US)

(72) Inventors: Joern Kohlscheen, Forchheim (DE); Christian Bareiss, Forchheim (DE)

(21) Appl. No.: 19/186,353

(22) Filed: Apr. 22, 2025

(51) Int. Cl. C04B 41/45; C04B 41/00; C04B 41/50; C04B 41/52

(52) U.S. Cl. CPC C04B 41/4529; C04B 41/009; C04B 41/5063; C04B 41/5068; C04B 41/52; C04B 2235/3217; C04B 2235/3232; C04B 2235/3418; C04B 2235/3813; C04B 2235/3873

(57) ABSTRACT

Ceramic substrates with physical vapor deposited coatings are disclosed. An adhesion layer between the ceramic substrate and PVD coating provides improved adhesion of the PVD coating. The ceramic substrate may be silicon-nitride based and/or silicon-oxide based. The PVD coating may comprise nitrides such as titanium nitride, aluminum nitride or titanium aluminum nitride. The adhesion layer may comprise titanium boride, titanium nitride or a combination thereof. An ion implant layer may be provided between the ceramic substrate and the adhesion layer.

### FIELD OF THE INVENTION

The present invention relates to ceramic substrates with physical vapor deposited coatings having improved adhesion.

### BACKGROUND INFORMATION

Ceramic materials are typically more difficult to coat than metal based-substrates due to poor or non-existing electrical conductivity and lattice mismatch between the ceramic substrate and coating materials.

### SUMMARY OF THE INVENTION

Ceramic substrates with physical vapor deposited coatings are provided. An adhesion layer between the ceramic substrate and PVD coating provides improved adhesion of the PVD coating. The ceramic substrate may be silicon-nitride based and/or silicon-oxide based. The PVD coating may comprise nitrides such as titanium nitride, aluminum nitride or titanium aluminum nitride. The adhesion layer may comprise titanium boride, titanium nitride or a combination thereof. An ion implant layer may be provided between the ceramic substrate and the adhesion layer.

An aspect of the present invention is to provide a coated ceramic substrate comprising a ceramic substrate, an adhesion layer comprising Ti(BₓN₂₋ₓ) on at least a portion of the ceramic substrate, and a PVD coating on at least a portion of the adhesion layer.

Another aspect of the present invention is to provide a method of physical vapor depositing a coating on a ceramic substrate comprising depositing an adhesion layer comprising Ti(BₓN₂₋ₓ) on a ceramic substrate, and physical vapor depositing a PVD coating over at least a portion of the adhesion layer.

These and other aspects of the present invention will be more apparent from the following description.

### BRIEF DESCRIPTION OF THE DRAWINGS

FIG. 1 a schematic diagram illustrating a ceramic substrate with an adhesion layer and a PVD coating.

### DETAILED DESCRIPTION

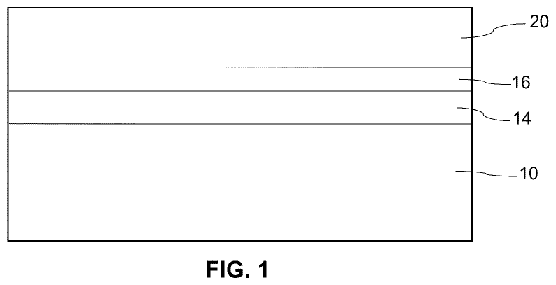

FIG. 1 schematically illustrates a ceramic substrate 10 with a physical vapor deposited (PVD) coating layer 20, an intermediate adhesion layer 16 and an optional ion implant layer 14. The ceramic substrate 10 may comprise nitrides, oxides, carbides, borides and combinations thereof. As used herein, when referring to the substrate, the term “ceramic” includes ceramic materials and ceramic-containing materials that include substantial amounts of ceramics such as cermet composite materials. Examples of nitrides include silicon nitrides, aluminum nitrides, silicon aluminum nitrides and the like. Examples of oxides include aluminum oxides, silicon oxides, aluminum silicon oxides and the like.

The ceramic substrate 10 may be silicon nitride-based and/or silicon oxide-based, such as silicon nitride (SiN x), silicon aluminum nitride (Si/AlNₓ), silicon oxide (SiOₓ), silicon aluminum oxide (Si/AlOₓ), silicon nitride doped with aluminum and oxygen (SiAlON), and the like. Alternatively, the ceramic substrate 10 may comprise aluminum oxide-based ceramics such as aluminum oxide (AlOₓ), aluminum silicon oxide (Al/SiOₓ), and the like.

The ceramic substrate 10 may have a crystal structure that does not match the crystal structure of the PVD coating 20 to be applied to the ceramic substrate. For example, a SiAlON ceramic substrate material may have a hexagonal crystal structure (P6 group) different from a non-hexagonal crystal structure of a PVD coating, such as titanium aluminum nitride coatings having a cubic crystal structure. Such crystal structure mismatches, e.g., between a SiAlON ceramic substrate and a TiAlN PVD coating, may contribute to poor adhesion of the coating on the substrate.

The deposited adhesion layer 16 may comprise borides, nitrides and combinations thereof. Examples of borides include titanium borides, zirconium borides, chromium borides, vanadium borides, molybdenum borides, other transition metal borides, or combinations thereof. Examples of nitrides include titanium nitrides, zirconium nitrides, chromium nitrides, vanadium nitrides, molybdenum nitrides, other transition metal nitrides, or combinations thereof.

For example, the adhesion layer 16 may comprise titanium boride (TiB x), titanium nitride (TiNₓ), or a combination thereof (Ti(BₓN₂₋ₓ)). The stoichiometry of a Ti(BₓN₂₋ₓ) adhesion layer may be constant throughout its thickness, or may be varied. For example, the adhesion layer may be B-rich when initially deposited on the ceramic substrate and may transition to N-rich during subsequent deposition, e.g., TiB₂ deposition, followed by Ti(BₓN₂₋ₓ) deposition, followed by TiN deposition to form a graded adhesion layer.

The composition of the adhesion layer 16 may be controlled to produce a crystal structure that facilitates adhesion of the subsequently deposited PVD coating 20. For example, the adhesion layer 16 may have a cubic crystal structure, a hexagonal crystal structure or a crystal structure that transitions from hexagonal adjacent to the ceramic substrate to cubic adjacent to the PVD coating. For example, when the ceramic substrate comprises SiAlON and the PVD coating comprises TiAlN, the adhesion layer may comprise TiB₂ having a hexagonal crystal structure adjacent to the SiAlON ceramic substrate or ion implant layer that transitions to cubic Ti(BₓN₂₋ₓ) or TiN adjacent to the TiAlN PVD coating. TiB₂ is very similar in lattice structure to non-cubic SiAlON (i.e. hexagonal, P6 group).

The adhesion layer 16 may have a typical thickness of from 0.001 to 0.3 micron, for example, from 0.005 to 0.2 micron. The PVD coating layer 20 may be deposited directly on the as-deposited adhesion layer, or the adhesion layer 16 may be further processed before the PVD coating layer is deposited, e.g., by additional etching at pulsed or preferably constant voltage applied to the substrate table.

The adhesion layer 16 may have a titanium concentration, as measured by EDS as described below, of at least 0.5 atomic percent, or at least 1 atomic percent, or at least 2 atomic percent, or at least 3 atomic percent, up to 5 or 10 atomic percent or more.

The adhesion layer 16 may be deposited on at least a portion of the ceramic substrate 10 by evacuating a coating chamber to at least 5 mPa, heating for at least 1 hour to at least 500° C., backfilling the chamber with argon working gas to a pressure of 0.1 to 0.5 Pa, etching by applying a bi-polar pulsed voltage to the substrate (for example 650 V peak negative voltage at a frequency of 240 kHz) for a duration of 20-60 min, then evaporating at least one sputter target, e.g., with an average power of 2 to 10 KW at a frequency of 0.1 to 5 kHz while applying a constant, uni-polar, or bi-polar pulsed voltage to the substrate of, for example, 20 to 100 V. Coating deposition can be carried out in a non-reactive or a reactive mode with nitrogen or other suitable gases. In a non-reactive process mode, the target material may comprise the hard compound to be deposited, e.g. TiN and/or TiB₂. In a reactive process mode, the target material may be a pure metal or an alloy such as Ti, Cr or TiAl evaporated at sufficient nitrogen flow to form a hard compound on the substrate. Depending on the adjusted parameters, a deposition step may take for example 1 to 2 hours.

The PVD coating 20 may comprise nitrides, borides, oxides, carbides, and combinations thereof. Examples of nitrides include titanium nitride (TiN x), aluminum nitride (AlNₓ), titanium aluminum nitride (Ti/AlNₓ), and the like. Such nitride PVD coatings may have cubic crystal structures that would not normally bond or adhere well to a non-cubic ceramic substrate. However, by providing the present adhesion layer 16, improved adhesion may be achieved.

The PVD coating 20 may have a typical thickness of from 0.5 to 5 microns, for example, from 1 to 3 microns, or from 1.5 to 2.5 microns.

The physical deposition process may be conducted by standard procedures known to those skilled in the art. For example, the PVD coating layer may be produced by pulsed sputter deposition using commercial PVD equipment such as a CemeCon CC800, Balzers Ingenia, or the like.

As shown in FIG. 1, an ion implant layer 14 may be provided between the ceramic substrate 10 and the adhesion layer 16. The ions used to produce the ion implant layer 14 may comprise Ti, B, or combinations thereof. The atomic ratio of Ti to B may be determined by the source material (“target”) used for deposition (non-reactive mode). A common stoichiometric composition of target material is TiB₂ but other compositions are also possible. For example, the Ti:B atomic ratio may range from 2:1 to 1:2, e.g. TiBₓ where X is from 0.5 to 2.

The ion implant layer 14 may extend into the ceramic substrate 10 by an infiltration distance or thickness of from 0.001 to 0.05 micron, for example, from 0.005 to 0.01 micron.

The ion implant layer 14 may be produced by evacuating the coating chamber to at least 5 mPa, heating for at least 1 hour to >500 C, backfilling the chamber with argon working gas to a pressure of 0.1 to 0.5 Pa, applying an uni-polar or bi-polar pulsed voltage to the substrate table (for example peak negative voltages of 800-1200 V at a frequency of for example 0.1 to 5 kHz), evaporating at least one sputter target, e.g., with an average power of 2 to 10 KW at a frequency of 0.1 to 5 kHz for a duration of for example 1 to 30 min. The ion implantation process may be performed with the PVD equipment described above.

The ion implant layer 14 may include defects in the crystal structure of the ceramic substrate induced by the ion implantation process. Although not intending to be bound by theory, the ion implantation layer 14 may possibly comprise a doped ceramic material with A-site and/or B-site atomic substitutions. For example, a SiAlON ceramic substrate that is ion implanted with Ti and B may have Ti partially substituted for Si and/or Al at the A-site, and B partially substituted for N and/or O at the B-site.

The following examples are intended to illustrate various aspects of the present invention and are not intended to limit the scope of the invention.

### EXAMPLES

Ceramic substrates were processed by the steps of ion implanting, adhesion layer deposition, etching, and PVD coating for the time periods listed in Table 1 (minutes). The ceramic substrates of the listed samples comprised SiAlON in the form of CNMG style inserts, K ennametal grade KY S30, with ground surfaces.

TABLE 1

| | |
|---|---|
| Process step duration | Sample No. |

| (minutes) | 1 | 2 | 3 | 4 | 5 | 6 |
|---|---|---|---|---|---|---|
| Implantation Ti/B | 10 | 10 | 10 | 10 | 10 | 10 |
| Adhesion layer TiB₂ | 10 | 10 | 20 | 40 | 20 | 20 |
| Etching | 40 | 20 | 20 | 20 | 10 | 0 |
| PVD coating | 60 | 60 | 60 | 60 | 60 | 60 |

The PVD coating comprised AlTiN (Al:Ti elemental ratio of about 1.5:1) with about 3 micron thickness deposited in reactive mode by pulsed sputtering as described previously.

Table 2 lists Ti concentrations and critical load measurements obtained for sample nos. 1, 2, 3, 5 and 6 of Table 1. Titanium concentration was measured by energy dispersive x-ray spectroscopy (EDS) prior to the PVD coating step. Adhesion or critical load was determined on PVD coated samples with same processing sequence, e.g. the same samples were continued to be used after EDS measurement and cleaning or different samples were used but with same etching sequence plus PVD coating. Critical loads were measured by scratch testing with a diamond stylus in accordance with ASTM C1624-22. Scratch testing is often used to evaluate and rank PVD coatings and determines the maximum normal load before a coating starts to delaminate from a sufficiently hard substrate such as ceramics.

TABLE 2

| Sample No. | Ti conc. [at. %] | critical load [N] |
|---|---|---|
| 1 | 0 | 37 |
| 2 | 0 | 37 |
| 3 | 0.3 | 42 |
| 5 | 3.5 | 70 |
| 6 | 3.7 | 60 |

According to Table 2, the samples with Ti concentrations around 3.5 atomic % result in the highest critical load values (i.e. best adhesion) of an AlTiN coating on the SiAlON ceramic substrate when applying normal and shear loads.

A longitudinal turning test was performed with comparative and inventive samples of SiAlON substrate material. Table 3 lists cutting parameters that were used. Workpiece material was IN718 with a hardness of 385 HBN, and external coolant was applied.

TABLE 3
Insert: RNGN120700T0120 (ISO)/RNGN45T0320 (AISI)

| | | | | |
|---|---|---|---|---|
| speed | 200 | m/min | 656 | sfm |
| depth of cut | 0.5000 | mm | 0.0197 | inches |
| feed | 0.2000 | mmpr | 0.0079 | ipt |
| max. flank wear | 0.4000 | mm | 0.0157 | inches |

Table 4 lists the obtained tool life in minutes in two tests. KYS30 is the uncoated benchmark ceramic insert (without the present pre-treatment). A ITIN stands for a coated KYS30 insert with similar coating thickness as the inventive variant but without any implantation and adhesion layer. Sample No. 5 is an inventive variant defined by the process step 10-20-10-60 as described in Table 1 (values in minutes).

TABLE 4

| | KYS30 | AlTiN | Sample No. 5 |
|---|---|---|---|
| Test no. 1 | 2.97 | 3.53 | 4.11 |
| Test no. 2 | 3.12 | 3.79 | 4.10 |
| Average | 3.04 | 3.66 | 4.11 |
| Std. deviation | 0.11 | 0.18 | 0.00 |
| Tool life | 100% | 120% | 135% |

As shown in Table 4, the inventive process results in higher tool life not only of uncoated inserts but also of PVD coated inserts without inventive process steps.

As used herein, “including,” “containing” and like terms are understood in the context of this application to be synonymous with “comprising” and are therefore open-ended and do not exclude the presence of additional undescribed or unrecited elements, materials, phases or method steps. As used herein, “consisting of” is understood in the context of this application to exclude the presence of any unspecified element, material, phase or method step. As used herein, “consisting essentially of” is understood in the context of this application to include the specified elements, materials, phases, or method steps, where applicable, and to also include any unspecified elements, materials, phases, or method steps that do not materially affect the basic or novel characteristics of the invention.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances. In this application and the appended claims, the articles “a,” “an,” and “the” include plural referents unless expressly and unequivocally limited to one referent.

Whereas particular embodiments of this invention have been described above for purposes of illustration, it will be evident to those skilled in the art that numerous variations of the details of the present invention may be made without departing from the invention as defined in the appended claims.

1. A coated ceramic substrate comprising:
a ceramic substrate;
an adhesion layer comprising Ti(BₓN₂₋ₓ) on at least a portion of the ceramic substrate; and
a PVD coating on at least a portion of the adhesion layer.

2. The coated ceramic substrate of claim 1, wherein x ranges from 2 to 0.

3. The coated ceramic substrate of claim 1, wherein x ranges from 2 to 0.1.

4. The coated ceramic substrate of claim 1, wherein x is 2.

5. The coated ceramic substrate of claim 1, wherein the adhesion layer has a substantially uniform composition through a thickness of the adhesion layer.

6. The coated ceramic substrate of claim 1, wherein the adhesion layer has a non-uniform composition through a thickness of the adhesion layer.

7. The coated ceramic substrate of claim 6, wherein the adhesion layer comprises TiB₂ adjacent the ceramic substrate and comprises TiN adjacent the PVD coating.

8. The coated ceramic substrate of claim 1, wherein the adhesion layer has a thickness of from 0.005 to 0.2 micron.

9. The coated ceramic substrate of claim 1, wherein the adhesion layer comprises a titanium concentration, as measured by energy dispersive X-ray spectroscopy, of at least 1 atomic percent.

10. The coated ceramic substrate of claim 9, wherein the titanium concentration is at least 3 atomic percent.

11. The coated ceramic substrate of claim 1, wherein the ceramic substrate comprises silicon nitride, silicon aluminum nitride, silicon oxide, silicon aluminum oxide, silicon nitride doped with aluminum and oxygen, aluminum oxide, aluminum silicon oxide, or combinations thereof.

12. The coated ceramic substrate of claim 1, wherein the PVD coating comprises titanium nitride, aluminum nitride, titanium aluminum nitride, or combinations thereof.

13. The coated ceramic substrate of claim 1, further comprising an ion implant layer between the ceramic substrate and at least a portion of the adhesion layer.

14. The coated ceramic substrate of claim 13, wherein the ion implant layer comprises Ti, B, or combinations thereof.

15. The coated ceramic substrate of claim 14, wherein the ion implant layer has a thickness of from 0.001 to 0.05 micron.

16. A method of physical vapor depositing a coating on a ceramic substrate comprising:
depositing an adhesion layer comprising Ti(BₓN₂₋ₓ) on a ceramic substrate; and
physical vapor depositing a PVD coating over at least a portion of the adhesion layer.

17. The method of claim 16, further comprising ion implanting a layer on the ceramic substrate prior to depositing the adhesion layer.
